(19) United States
(12) Patent Application Publication
(10) Pub. No.: US 2004/0136782 A1
(43) Pub. Date: Jul. 15, 2004

(54) T-link of two profiled sections

(76) Inventors: Wolfgang Rixen, Solingen (DE); Gerrit Pies, Solingen (DE)

Correspondence Address: GUDRUN E. HUCKETT DRAUDT, LONSSTR. 53, WUPPERTAL, 42289, DE

(21) Appl. No.: 10/475,669

(22) PCT Filed: Mar. 30, 2002
(86) PCT No.: PCT/EP02/03586

(30) Foreign Application Priority Data
Apr. 26, 2001 (DE) 201 07 168.1

(51) Int. Cl. F16B 9/00

(52) U.S. Cl. 403/382

(57) ABSTRACT

In order to improve a T-link such that the connecting strength is improved, it is embodied such that the clamped inner webs are to be held together positive-lockingly by the clamping jaws (6).

The invention relates to a T-link of two profiled sections, comprising a connector having two elongate clamping jaws that can be transversely clamped by a fixation element, wherein the clamping jaws can be clamped such they close like pliers in undercut grooves of the outer surface of the second profiled section and engage a cavity of a first profiled section provided at an end face and can also be clamped on inner webs of the first profiled section that are arranged between them and extend tube-parallel, wherein the first profiled section has more than two inner webs that are uniformly distributed about its inner circumference and are positioned diametrically opposite one another, wherein the clamping jaws can be clamped thereon in a longitudinal direction with linear and/or areal contact and, in this way, are to be held together against spreading loads acting in the plane of the clamped inner webs of the first profiled section.

A T-link having the aforementioned features is disclosed in WO 00/34670. The longitudinal edges of the clamping jaws enclose an inner web between them. The clamping surfaces of the clamping jaws and the clamping surfaces of the inner webs are planar, respectively. In this way, a purely nonpositive connection between the clamping jaws and the inner webs is realized. The clamping force effective in this connection depends on the fixation element with which the clamping jaws are clamped. At the same time, the fixation elements also serves for clamping the clamping jaws on undercut grooves of the outer surface of the second profiled section in a pliers-like engagement. Accordingly, it cannot be precluded that tolerances in the area of the second profiled section have effects on the clamping force of the clamping jaws on the first profiled section or on its inner webs. Accordingly, this can result in undesirable clamping force fluctuations so that the stability of the connection is different, accordingly. Moreover, loads of the profiled sections can result in that the inner webs are not clamped tightly enough by the clamping jaws so that they can move and, in an extreme situation, can slip out of the clamping jaws when the deformation of the profiled section is large enough. In this case, the stability of the connection of the T-link is affected in an undesirable way.

It is therefore an object of the invention to configure a T-link having the aforementioned features such that the stability of the connection is improved.

The aforementioned object is solved in that the clamped inner webs are to be held together in a positive-locking way by the clamping jaws.

It is important in connection with the invention to deviate from the pure nonpositive action of the connection between the clamping jaws and the inner webs. Instead, the clamped inner webs are to be held together in a positive-locking way by the clamping jaws. The invention is based on the recognition that in most construction situations loads will occur that will lead to a deformation of the first profiled section where the inner webs have a tendency to be pulled transversely out of the clamping jaws. The utilization of a positive-locking engagement of the inner webs results accordingly in a significant stabilization of the T-link even when load components are present which result in a tendency of deformations of the first profiled section perpendicularly to the plane defined by the clamped inner webs.

An expedient embodiment of the afore described positive-locking connection between the inner webs and the clamping jaws is characterized in that the inner webs and the clamping jaws are to be positive-lockingly held together by means of coupling ribs and coupling grooves extending continuously in the longitudinal direction of the web. The embodiment of the coupling means as ribs and grooves ensures for the purpose of assembly positioning in the longitudinal direction at any location so that tolerances present in these directions have no effect on the desired fast clamping action. Clamping jaws of identical configuration can be used for different rod cross-sections and, primarily, also for different spacings of the first profiled section relative to the second profiled section, for example, in order to use covering caps between both rods.

It is advantageous to configure the T-link such that on the clamping jaws coupling ribs are provided that engage coupling grooves of the inner webs. The coupling ribs can be arranged near the edges so that the clamping jaws can be designed to be correspondingly narrow; this is advantageous for smaller and thus limited cross-sections of the first profiled section.

An advantageous positive-locking connection between the inner web and the clamping jaws results when the T-link is configured such that a coupling groove of an inner web is formed between two longitudinally extending web ribs. In this case, a positive-locking connection is ensured in both directions transversely to the inner webs. Accordingly, a deformation of the first profiled section in both directions transversely to the inner webs is prevented. The web ribs enable a high arrangement of the coupling groove relative to the cross-section center of the inner webs and thus a greater thickness of the web in the area of the coupling groove.

It is preferred that the inner web in the area of a coupling groove is practically of the same thickness as in the connecting area at the inner circumference of the first profiled section. In this way, a stability of the inner web is ensured that is practically of the same magnitude in the area of the coupling ribs as in the connecting area of the inner web on the inner circumference of the first profiled section.

A further improvement of the connection between the clamping jaw and the inner webs results when the inner webs are provided on both sides with a coupling groove, respectively, and each clamping jaw is provided on both sides with a coupling rib, respectively. By means of the resulting doubling of the coupling means it is achieved that the specific loading of the coupling means can be reduced accordingly. It is possible to reduce the projections and recesses of the coupling ribs and coupling grooves required for the positive-locking coupling action with regard to their size.

For a universal utilization of the clamping jaws and of the profiled sections it is advantageous when all inner webs of a profiled section are formed with identically sized coupling ribs and coupling grooves. In this way, an often disruptive preferred positioning of the profiled section for assembly is prevented.

The T-link can be configured such that the first profiled section has a round cross-section and the inner webs have in the attachment area at the inner circumference of the first profiled section a spacer web section extending to the coupling groove. The spacer web section takes into consideration the curvature of the profiled section such that the clamping jaws can engage at a greater spacing from its inner circumference and therefore do not hit with their longitudinal edges the profiled section.

A further special T-link is characterized in that the first profiled section has a square cross-section and has a single, centrally arranged inner web at the inner circumference of each section. This embodiment enables, in particular for small square cross-sections of the profiled section, the configuration of clamping jaws having a thick cross-section. In an extreme situation, the cross-section of a clamping jaw can extend across half the cross-section of the profiled section. In this connection, only the presence of the inner web that is not used for clamping must be taken into account.

The aforementioned configuration of the T-link is particularly suitable for greater loads in that the inner web, starting from a coupling groove, adjoins with a reinforcement bead the inner circumference of the rod wall.

The invention will be explained with the embodiments illustrated in the drawing. It is shown in:

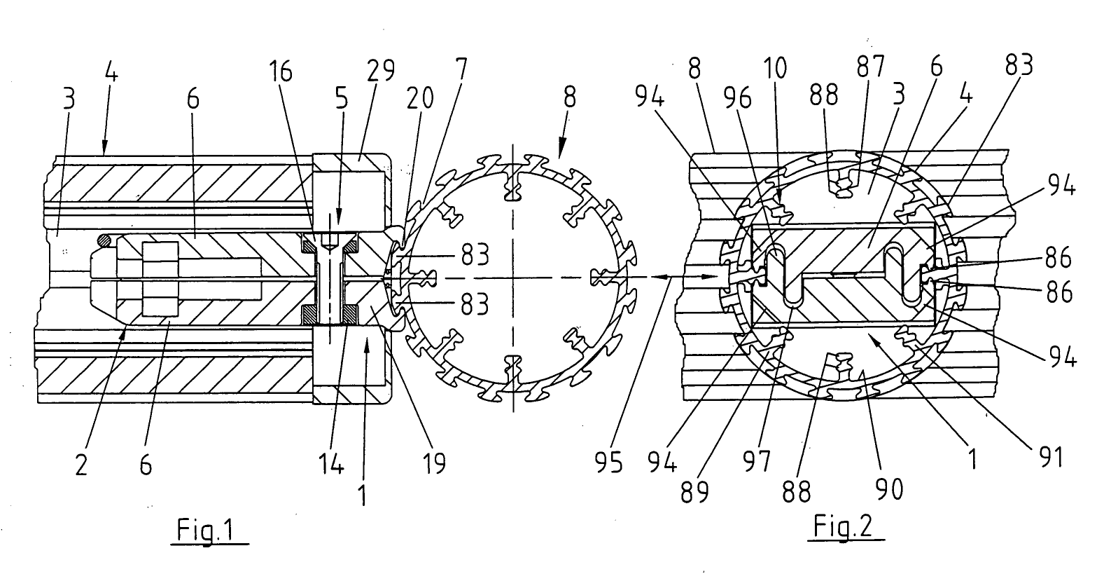

FIG. 1 a longitudinal section of a first embodiment of a T-link;

FIG. 2 a cross-section of the first profiled section of the T-link of FIG. 1;

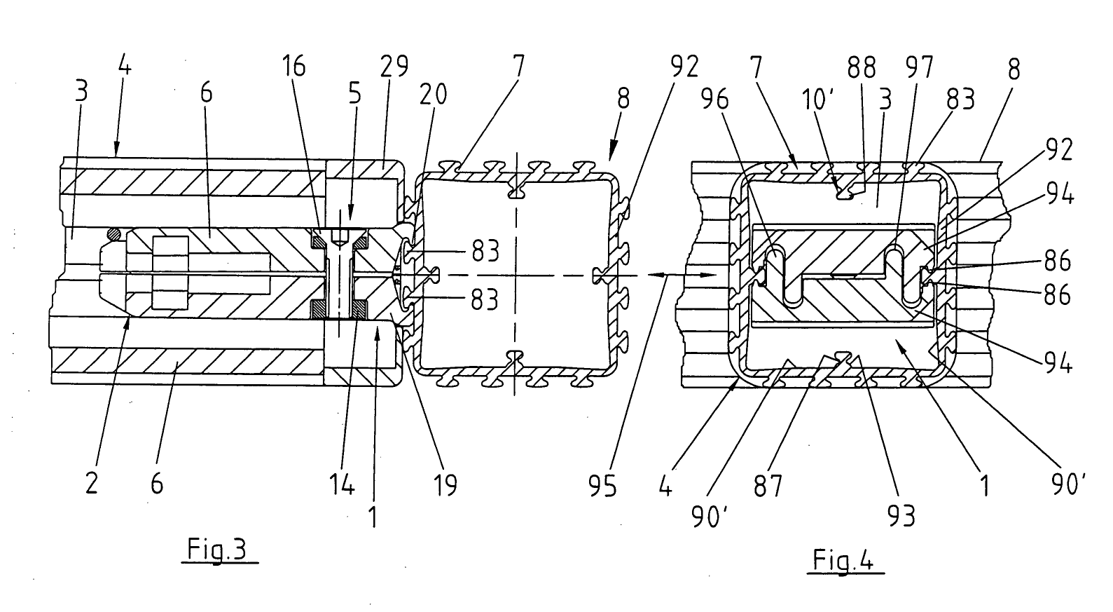

FIGS. 3, 4 illustrations corresponding to FIGS. 1, 2 of T-links of two square profiled sections.

The FIGS. 1, 2 show a connection of a first profiled section 4 with a second profiled section 8 by means of a connector 1. The profiled sections 4, 8 are tubular and have a substantially circular cross-section. The outer circumference of each profiled section 4, 8 is provided with undercut grooves 7 on the outer surface so that outer webs 83 are formed accordingly. These outer webs 83 and the grooves 7 on the outer surface forming them are present on the profiled sections 4, 8 in order to be able to connect them mechanically.

The connector 1 is comprised of two clamping jaws 6 of a solid configuration. The clamping jaws 6 engage with leg ends 20 of the jaw legs 19 of the clamping jaws the profiled section 8. When doing so, the leg ends 20 engage between them two outer webs 83 of the profiled section 8 like pliers. The clamping forces to be exerted in this connection are applied by a fixation element 5.

The fixation element 5 is arranged between the jaw legs 19 and an insertion end 2 of the connector 1 in the area between the profiled section 4 and the profiled section 8 so that it is accessible accordingly.

The fixation element 5 has a screw which is screwed into a nut 14. The clamping jaws 6 are tightened between this clamping nut and a screw head 16 and compressed so that the leg ends 20 are secured in the undercuts of the grooves 7 on the outer webs 83. As soon as the fixation process is completed, the end face of the profiled section 4 facing the profiled section 8 can be closed by a covering cap 29 so that the jaw legs 19 of the clamping jaws 6 are practically no longer visible and the fixation element 5 is also covered.

When actuating the fixation element 5 of the connector 1, the latter must be connected to the profiled section 4 such that the T-link of the two profiled sections 4, 8 becomes effective. For this purpose, the profiled sections 4, 8 and, in particular, the profiled section 4, are provided with inner webs; they are referenced in FIGS. 1, 2 at 10 and in FIGS. 3, 4 at 10′ because their cross-sections differ. However, they have in common that two inner webs 10 or 10′ are positioned diametrically opposite one another. This enables, in particular, that two identically configured clamping jaws 6 can be employed in order to attach the connector 1 to the inner webs 10, 10′. For such an attachment, the clamping jaws 6 have longitudinal edges 94 so that between two adjacent longitudinal edges 94 of two clamping jaws 6 an inner web 10, 10′ can be clamped, respectively. When actuating a fixation element 5 in the sense of clamping the clamping jaws 6, the longitudinal edges 94 are supported on the inner webs 10, 10′ and clamp them tightly therebetween. In this way, it is achieved that the connector 1 cannot be pulled out longitudinally from the profiled section 4 when the loads acting of the connector 1 are kept within the limits of the range that is set by the construction. The T-link of the two profiled sections 4, 8 is used in constructions where the loads occur not only in the longitudinal directions of the rods. Instead, transverse loads also occur, for example, bending or torsional loads of constructions assembled from profiled sections. When, for example, the profiled section 4 in FIG. 1 is vertically loaded, the profiled section 4 has a tendency to deform ovally. Its cross-section no longer would be circular, as illustrated in FIG. 2, but oval. Inner webs with planar clamping surfaces can then be loaded such that the nonpositive connection no longer functions. Spreading and thus a corresponding destabilization of the T-link would occur. In an extreme situation, an inner web would slip out of its clamping position between two longitudinal edges 94 of the clamping jaws 6. In order to prevent this, the inner webs 10, 10′ are provided with coupling grooves 87 that extended longitudinally in the direction of the inner webs 10, 10′. They are thus manufactured simultaneously with the profiled sections 4, 8, i.e., by extrusion. Accordingly, their manufacturing expenditure is correspondingly minimal.

Because of the cross-section of configuration of the profiled sections 4, 8, the inner webs 10, 10′ are differently configured. The inner webs 10 are longer than the inner webs 10′. The inner webs 10 engage with their projections 89 the inner periphery 90 of the first profiled section 4 by means of a spacer web section 91. Two web ribs 88 adjoin the spacer web section 91 on both sides and engage between them a coupling groove 87, respectively. The web ribs 88 constitute an enlargement of the cross-section and thus contribute also to a stiffening of the profiled section 4, 8. On both sides of the inner webs 10, two ribs 88 with intermediately positioned coupling grooves 87 are provided. A coupling rib 86 of a clamping jaw 6 engages each one of the coupling grooves 87 so that each clamping jaw 6 with each one of the longitudinal edges 94 positive-lockingly engages an inner web 10, i.e., positive lockingly relative to spreading loads which act in a plane of the inner webs 10 engaged by the clamping jaws 6. The main directions of these spreading loads in a bending situation of the profiled section 4 are indicated in FIG. 2 by the double-headed arrow 95. These are thus the directions into which the inner webs 10 with their cross-sections are pointing according to FIG. 2.

As a result of the web ribs 88 being present on either side of the coupling grooves 87, a positive-locking connection is provided in both directions 95. For reasons of stability, when shaping the cross-section of the inner webs 10, attention must be paid that the inner web 10, in the area of the two oppositely positioned grooves 87, is practically of the same thickness as in a connecting area 89 on the inner circumference 90 of the first profiled section 4 or the spacer web section 91.

When configuring the inner webs 10′ according to FIGS. 3, 4, a spacer web section 91 is not required. As a result of this, the coupling grooves 87 can be located very closely to the inner circumference 90′ of the profiled section 4. From the coupling ribs 87 a transition in the form of a reinforcement bead 93 into the inner circumference 90′ is provided.

Accordingly, only a single longitudinally extending web rib 88 on each side of the inner web 10′ is formed. The spacing between the two coupling grooves 87 is such that the stiffness of the inner web 10′ relative to tensile loads acting in the direction 95 is sufficient.

The profiled sections 4, 8 of FIGS. 4, 3 are of a special configuration in comparison to the previous embodiments in that on each rod wall 92 only a single inner web 10′ is formed. The four inner webs 10′ of the square profiled section 4, 8 are centrally arranged, respectively. Accordingly, the connector 1 can be inserted into and fastened on the profiled section only in the position illustrated in FIG. 4, or when rotated by 90°. In no situation is there a risk that the clamping jaws 6 could be hindered by the rod walls 92; this would be the case in FIG. 2 if the inner webs 10 were not provided with spacer web sections 91 or were correspondingly longer. In the case of the circular cross-sections of the profiled sections 4, 8 it is however expedient when the clamping jaws 6 with longitudinal edges engage an intermediate space which is formed between the clamped inner web and the neighboring inner web. The clamping jaws 6 can then be formed to be correspondingly stronger; this results in an improved support of the coupling ribs 86 or the longitudinal edges 94 of the clamping jaws 6.

The clamping jaws 6 according to FIGS. 2, 4 are connected parallel to the coupling ribs 86 in a positive-locking way in the directions 95. This positive-locking action is effected by alternatingly arranged projections 96 and recesses 97 which have very large cross-sections so that a corresponding stabilization of the mutual engagement of the clamping jaws 6 between the webs 10, 10′ results; this is advantageous with regard to the loads to be distributed.

1. A T-link of two profiled sections, comprising a connector (1) having two elongate clamping jaws (6) that can be transversely clamped by a fixation element (5), wherein the clamping jaws (6) can be clamped such that they close like pliers in undercut grooves (7) of the outer surface of the second profiled section (8) and engage a cavity (3) of a first profiled section (4) provided at an end face and can also be clamped on inner webs (10, 10′) of the first profiled section (4) that are arranged between them and extend tube-parallel, wherein the first profiled section (4) has more than two inner webs (10, 10′) that are uniformly distributed about its inner circumference and are positioned diametrically opposite one another, wherein the clamping jaws (6) can be clamped thereon in a longitudinal direction with linear and/or areal contact and, in this way, are to be held together against spreading loads acting in the plane of the clamped inner webs (10) of the first profiled section (4), characterized in that the clamped inner webs (10, 10′) are held together positive-lockingly by the clamping jaws (6).

2. The T-link according to claim 1, characterized in that the inner webs (10, 10′) and the clamping jaws (6) are held together by means of continuous coupling ribs (86) and coupling grooves (87) extending in the direction of the web.

3. The T-link according to claim 1 or 2, characterized in that on the clamping jaws (6) coupling ribs (86) are formed which engage coupling grooves (87) of the inner webs (10, 10′).

4. The T-link according to claim 2 or 3, characterized in that one coupling groove (87) of an inner web (10) is formed between two longitudinal continuous web ribs (88).

5. The T-link according to one of the claims 2 to 4, characterized in that the inner web (10) in the area of a coupling groove (87) is practically of the same thickness as in a connecting area (89) on the inner circumference (90) of the first profiled section (4).

6. The T-link according to one of the claims 1 to 5, characterized in that the inner webs (10, 10′) are provided on both sides with a coupling groove (87), respectively, and in that each clamping jaw (6) is provided on both sides with a coupling rib (86), respectively.

7. The T-link according to one of the claims 1 to 6, characterized in that all inner webs (10, 10′) of a profiled section (4) are formed with coupling ribs (86) and coupling grooves (87) of identical size.

8. The T-link according to one of the claims 1 to 7, characterized in that the first profiled section (4) has a round cross-section and the inner webs (10) have a spacer web section (91) extending up to a coupling groove (87) in a connecting area (89) on the inner circumference (90) of the first profiled section (4).

9. The T-link according to one of the claims 1 to 7, characterized in that the first profiled section (4) has a square cross-section and, on the inner circumference (90′) of each rod wall (92), has a single, centrally arranged inner web (10′).

10. The T-link according to claim 9, characterized in that the inner web (10′) of a coupling groove (87) adjoins with a reinforcement bead (93) the inner circumference (90′) of the rod wall (92).
